(19) United States
(12) Patent Application Publication
(10) Pub. No.: US 2009/0033160 A1
(43) Pub. Date: Feb. 5, 2009

(54) ELECTRIC MOTOR FOR HYBRID OR ELECTRIC VEHICLE

(76) Inventor: Daniel Mueller, Bloomfield, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/831,241

(22) Filed: Jul. 31, 2007

(51) Int. Cl. H02K 7/00; H02K 5/04; H02K 7/04; H02K 9/00; H02K 7/116; H02K 5/16

(52) U.S. Cl. 310/58; 310/67 R; 310/80; 310/83; 310/89; 310/90; 475/149

(57) ABSTRACT

A motor includes a stator, a rotor supported by a rotor hub for rotation relative to the stator, and a housing fixedly supporting the stator. The housing rotatably supports the rotor and includes a first end enclosing the stator, the rotor, and the rotor hub and a second end exposing the stator, the rotor, and the rotor hub to define an opening between the rotor and within the rotor hub.

### FIELD

The present invention relates to electric motors and more particularly to an improved electric motor for use in a vehicle.

### BACKGROUND

Electric motors are used in various applications to provide a rotational force to a drive shaft. For example, electric motors are commonly incorporated into a compressor to rotate a compression mechanism and compress a fluid disposed within the compressor. Such electric motors may be incorporated into a conventional vehicle to aid in starting a combustion engine of the vehicle and may be incorporated into various subsystems of the vehicle such as a blower assembly of an automotive heating, ventilation, air conditioning system. While conventional vehicles utilize electric motors to aid in starting a combustion engine or to drive a subsystem of the vehicle, conventional vehicles typically do not include an electric motor disposed within or associated with a transmission of the vehicle. Therefore, the overall size and weight of an electric motor used in conjunction with a conventional vehicle is of little concern when designing a transmission of the vehicle. Accordingly, conventional electric motors typically include a bulky housing that completely encases internal components of the electric motor, as packaging of such a motor within a transmission housing is of little concern.

### SUMMARY

A motor includes a stator, a rotor supported by a rotor hub for rotation relative to the stator, and a housing fixedly supporting the stator. The housing rotatably supports the rotor and includes a first end enclosing the stator, the rotor, and the rotor hub and a second end exposing the stator, the rotor, and the rotor hub to define an opening within the rotor and the rotor hub.

A transmission includes a stator, a transmission motor housing, and a motor disposed at least partially within the transmission motor housing. The motor includes a rotor supported by a rotor hub for rotation relative to the stator and a motor housing fixedly supporting the stator and rotatably supporting the rotor. The housing includes a first end enclosing the stator, the rotor, and the rotor hub and a second end exposing the stator, the rotor, and the rotor hub to define an opening within the rotor and the rotor hub.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a motor in accordance with the principles of the present teachings;

FIG. 2 is a cross-sectional view of the electric motor of FIG. 1;

FIG. 3 is a partial sectional view of the motor of FIG. 1 showing a stator and a rotor;

FIG. 4 is a partial sectional view of the motor of FIG. 1 showing a pair of bearings and a resolver assembly;

FIG. 5 is a side view of a balance disk for use with the motor of FIG. 1;

FIG. 6 is a front view of the balance disk of FIG. 5;

FIG. 7 is a side view of a balance disk for use with the motor or FIG. 1;

FIG. 8 is a front view of the balance disk of FIG. 7;

FIG. 9 is a cross-sectional view of the motor of FIG. 1 including a planetary-gear set incorporated generally within a housing of the motor; and

FIG. 10 is a cross-sectional view of a transmission of a vehicle incorporating the motor of FIG. 1 therein.

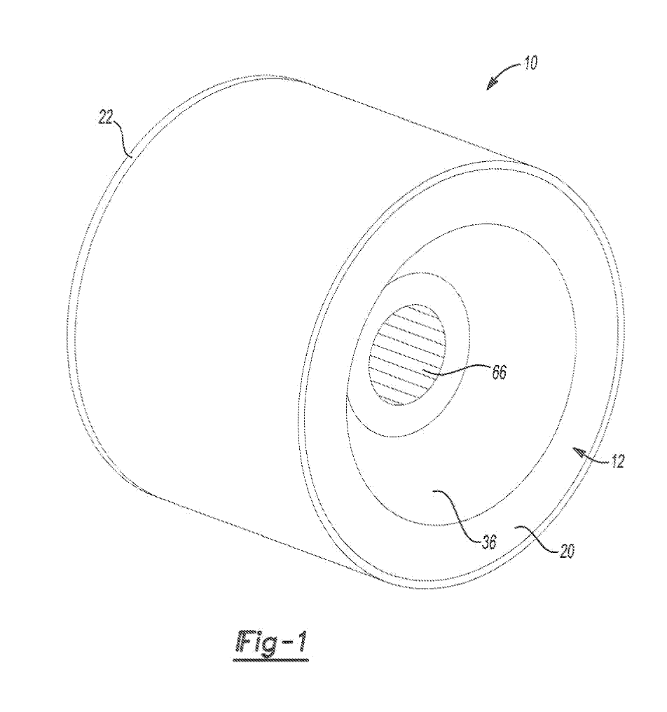

### DETAILED DESCRIPTION

The following description is merely exemplary in nature and is in no way intended to limit the invention, its application, or uses.

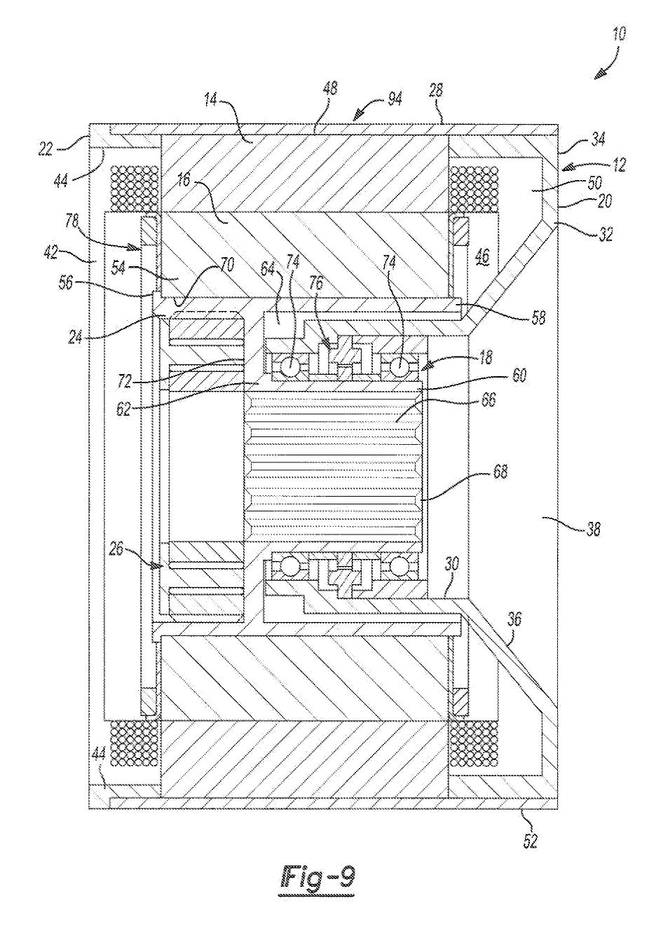

With reference to the figures, a motor 10 is provided and includes a housing 12, a stator 14, a rotor 16, and a bearing assembly 18. The bearing assembly 18 is disposed generally between the stator 14 and the rotor 16 and facilitates rotation of the rotor 16 relative to the stator 14. The housing 12 supports the stator 14, rotor 16, and bearing assembly 18 and includes a first end 20 that encloses the stator 14, rotor 16, and bearing assembly 18 and a second end 22 that exposes at least the stator 14 and rotor 16 to define an opening 24 within the housing 12. The opening 24 is at least partially disposed between the stator 14 and the rotor 16 to facilitate packaging of an external component, such as a planetary-gear set 26 (FIG. 9), at least partially within the housing 12 of the motor 10.

As noted above, the housing 12 includes a first end 20 that generally encloses the stator 14, rotor 16 and bearing assembly 18 and a second end 22 that is open and exposes at least the stator 14 and the rotor 16. The housing 12 includes a first wall 28 extending between the first and second ends 20, 22 and a second wall 30 spaced apart from the first wall 28 and similarly extending between the first and second ends 20, 22. The first wall 28 includes a greater length than the second wall 30 such that the second wall 30 extends only partially from the first end 20 of the housing 12 towards the second end 22 of the housing 12. The first wall 28 is substantially parallel to the second wall 30 and is joined to the second wail 30 by an end cap 32.

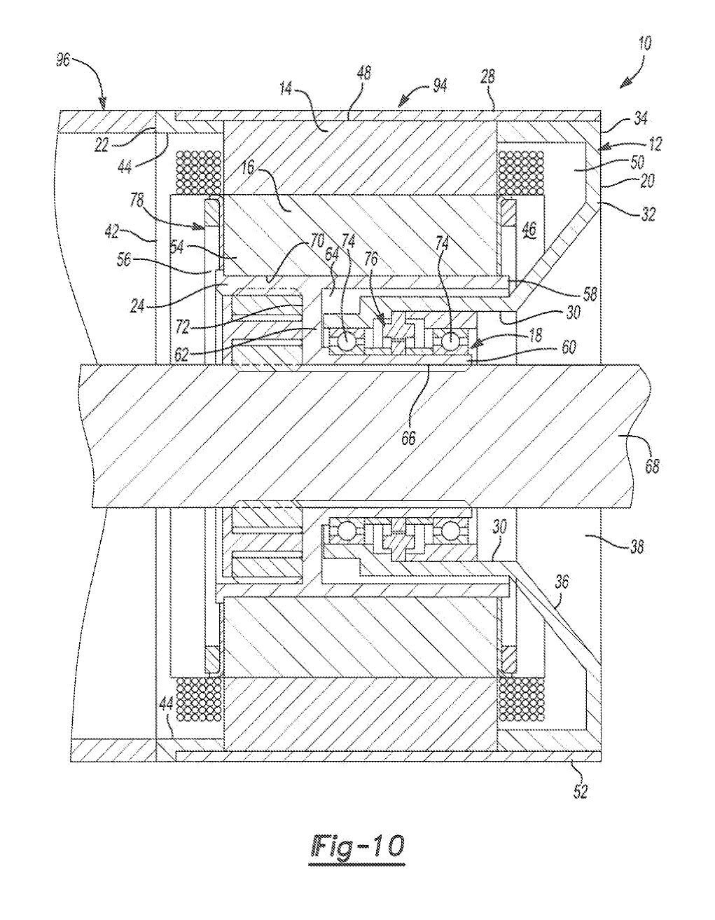

The end cap 32 may include a first portion 34 that is substantially perpendicular to the first and second walls 28, 30 and a second portion 38 that is positioned at an angle relative to the first and the second walls 28, 30. Positioning the second portion 36 of the end cap 32 at an angle relative to the first and second walls 28, 30 of the housing 12 reduces the overall size of the housing 12 and increases a recess 38 disposed generally at the first end 20 of the housing 12, as defined by the second portion 38 of the end cap 32. Increasing the size of the recess 38 facilitates packaging of the motor 10 within an external structure such as, for example, a transmission 40 (FIG. 10).

The second end 22 is disposed generally on an opposite end of the housing 12 from the first end 20 and includes an opening 42 having a diameter substantially equal to an inner diameter of the housing 12, as defined by an inner surface 44 of the first wall 28. The opening 42 disposed at the second end 22 of the housing 12 provides access to the opening 24, which is disposed at least partially between the stator 14 and rotor 16, as described above. Therefore, positioning the planetary-gear set 26 within the opening 24 is accomplished by inserting the planetary-gear set 26 within the opening 42 of the housing 12 prior to inserting the planetary-gear set 26 into the opening 24 defined at least partially between the stator 14 and the rotor 16.

As described above, the first wall 28 of the housing 12 is spaced apart and extends substantially parallel to the second wall 30 of the housing 12. Because the first wall 28 is spaced apart from the second wall 30, a pocket 46 is defined generally between the first wall 28, second wall 30, and end cap 32 of the housing 12. The pocket 46 at least partially receives the stator 14 and rotor 16.

The stator 14 is supported proximate to the first wall 28 of the housing 12 and includes an electromagnet 48 and a field coil 50. The field coil 50 selectively supplies energy to the electromagnet 48 to cause selective rotation of the rotor 16 relative to the stator 14. The electromagnet 48 of the stator 14 at least partially extends into the first wall 28 of the housing 12 to maximize the overall size of the electromagnet 48. Maximizing the electromagnet 48 increases the ability of the stator 14 in rotating the rotor 16 and, as a result, allows the rotor 16 to rotate at higher speeds and/or at greater torques.

The electromagnet 48 may extend at least partially into the first wall 28 such that the first wall 28 includes a localized thin spot proximate to the electromagnet 48. Conversely, the electromagnet 48 may include an outer diameter that is substantially equal to an outer diameter of the housing 12, as defined by an outer surface 52 of the first wall 28. Providing the electromagnet 48 within outer diameter that approximates the outer diameter of the housing 12 maximizes the overall size of the electro-magnet 48 and therefore maximizes the output of the motor 10 (i.e., speed and/or torque).

The rotor 16 is rotatably supported by the housing 12 relative to the stator 14 and includes a rotor stack 54 supported by a rotor hub 56. The rotor hub 56 includes a first extension 58, a second extension 60, and a cross member 62 joining the first extension 58 and second extension 60. The first extension 58, second extension 60, and cross member 62 cooperate to define a recess 64 that at least partially receives the housing 12 and bearing assembly 18.

The recess 64 at least partially receives the second wall 30 of the housing 12 such that the second wall 30 of the housing 12 rotatably supports the rotor hub 56. The bearing assembly 18 may be disposed between the second wall 30 of the housing 12 and the second extension 60 of the rotor hub 56 to facilitate rotation of the rotor hub 56 relative to the second wall 30 of the housing 12. While the bearing assembly 18 is described as being disposed between the second wall 30 of the housing 12 and the second extension 60, the bearing assembly 18 could alternatively or additionally be disposed between the second wail 30 of the housing 12 and the first extension 58 of the rotor hub 56.

The first extension 58 may include a sufficient length to fully engage and support the rotor stack 54 to ensure that the rotor stack 54 is fixed for rotation with the rotor hub 56. The second extension 60 is spaced apart from the first extension 58 by the cross member 62 and may include a series of splines 66 for engagement with a shaft 68 (FIG. 10) extending through the housing 12. Engagement between the splines 66 of the second extension 60 and the shaft 68 causes the shaft to rotate concurrently with the rotor hub 56 when the rotor hub 56 is rotated relative to the rotor 16.

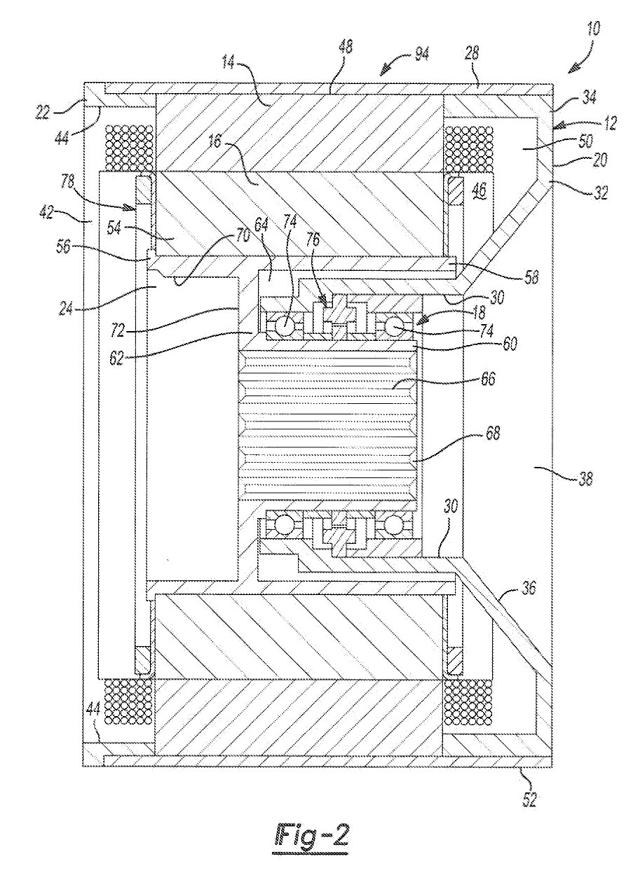

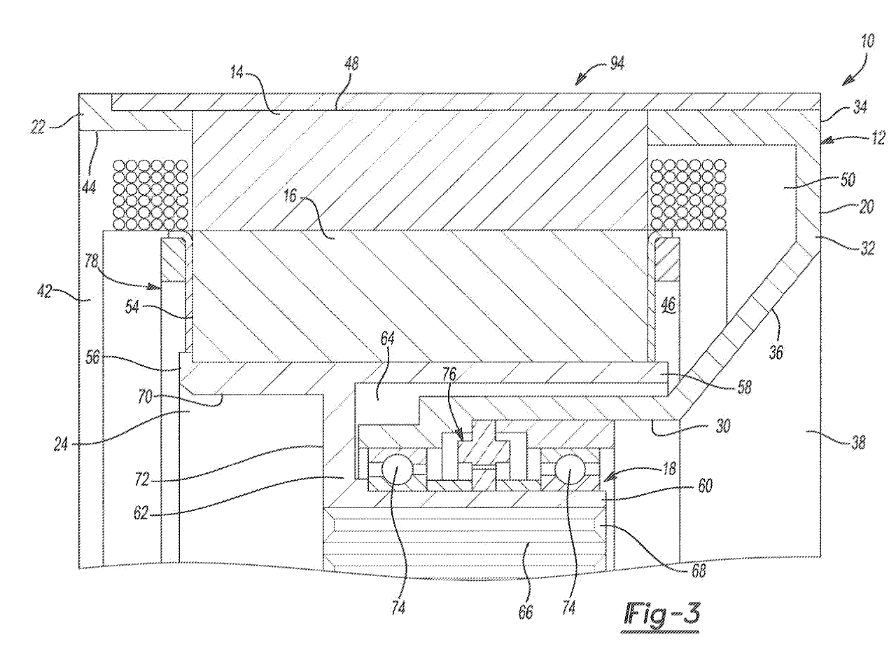

The opening 24 defined generally between the stator 14 and the rotor 16 may be at least partially defined by the rotor hub 56. For example, as shown in FIG. 2, the opening 24 may be defied generally between an inner surface 70 of the first extension 58 and an outer surface of the cross member 62. When the planetary-gear set 26 is received within the opening 24, the planetary gear-set 26 may at least partially engage one or both of the inner surface 70 of the first extension 58 and the outer surface 72 of the cross member 62 to attach the planetary-gear set 26 for rotation with the rotor hub 56. Alternatively, the planetary-gear set 26 may be received within the opening 24 without being rotated by the rotor hub 56 when the rotor hub 56 is rotated relative to the housing 12.

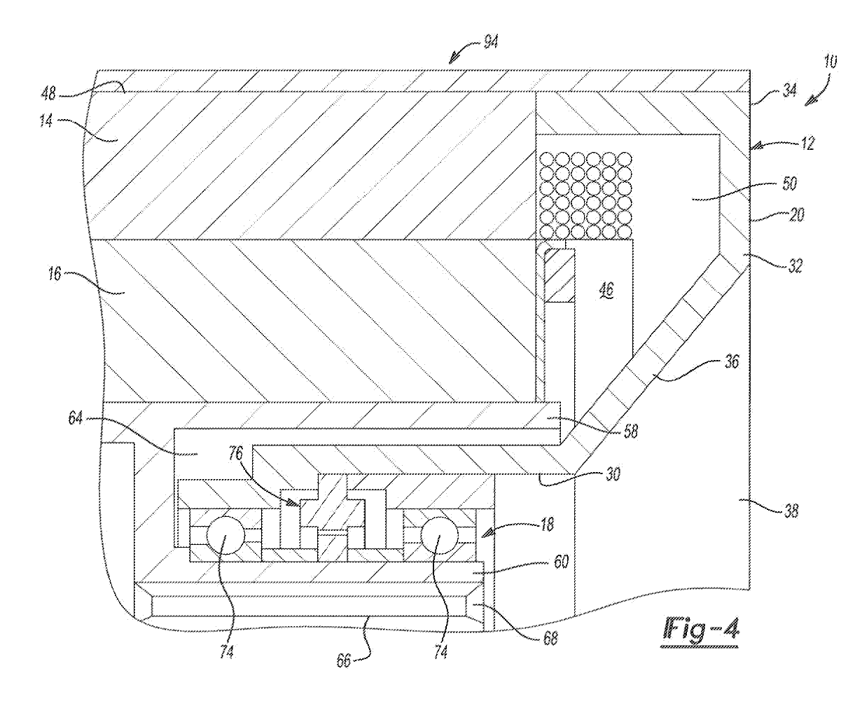

With particular reference to FIG. 4, the bearing assembly 18 is shown to include a pair of bearings 74 disposed generally between the second wall 30 of the housing 12 and the second extension 60 of the rotor hub 56. As described above, the bearings 74 facilitate rotation of the rotor hub 56 relative to the second wall 30 of the housing 12. The bearings 74 are separated along a length of the second extension 60 to ensure stability between the housing 12 and the rotor hub 56 to prevent radial play therebetween. As can be appreciated, the greater distance the bearings 74 are separated, the less likely the housing 12 will rotate relative to the rotor hub 56. Preventing rotation of the housing 12 relative to the rotor hub 56 or rotation of the rotor hub 56 relative to the housing maintains the first and second extensions 58, 60 in a generally parallel relationship relative to the second wall 30 of the housing 12. If the bearings 74 are disposed proximate to one another the bearings 74 may act as a pivot point, thereby allowing relative rotation between the second wall 30 of the housing 12 and the first and second extensions 58, 60 of the rotor hub 56 (i.e., radial play), which may adversely affect operation of the motor 10. Therefore, the bearings 74 are separated from one another along a length of the second extension 60 to maximize the stability of the connection between the rotor hub 56 and the second wall 30 of the housing 12.

Because the bearings 74 are separated along a length of the second extension 60 of the rotor hub 56, a resolver assembly 76 may be positioned between the bearings 74. Positioning the resolver assembly 76 between the bearings 74 encloses the resolver assembly 76 between the second wall 30 of the housing 12 and the second extension 60 of the rotor hub 56. In this, manner, the resolver assembly 76 is bounded on all sides (i.e., by the bearings 74, second wall 30 and second extension 60) and is protected from damage and/or manipulation. The resolver assembly 76 is positioned between the housing 12 and the rotor hub 56 and provides a signal indicative of a rotational speed of the rotor 16 relative to the stator 14.

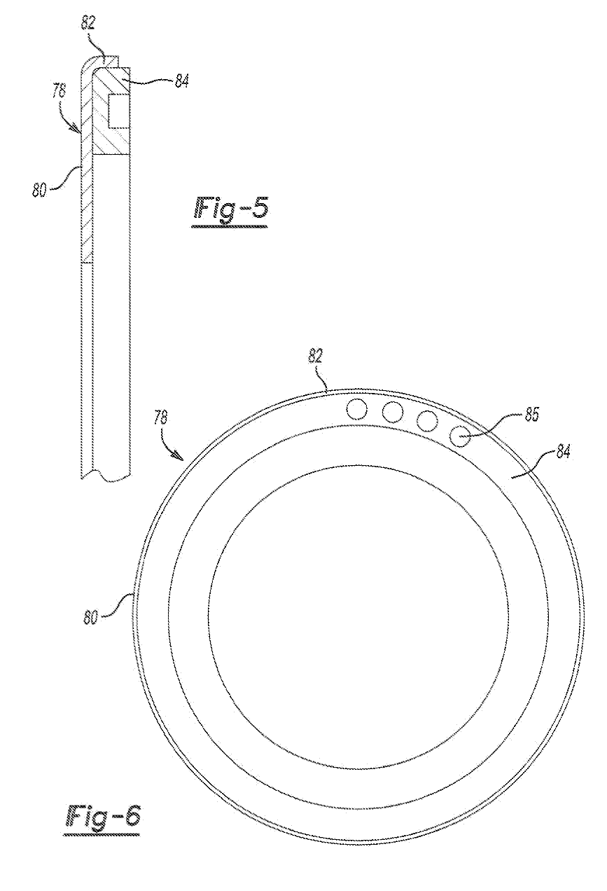

With particular reference to FIGS. 5 and 6, a balancing disk 78 is provided for use with the motor 10. The balancing disk 78 may be positioned on one or both ends of the motor stack 54 and may be fixed for rotation with the rotor stack 54 relative to the housing 12. The balancing disk 78 may include a substantially flat plate 80 having an annular flange 82 disposed at an outer perimeter thereof. A metal ring 84 may be positioned proximate to a junction of the flat plate 80 and the annular flange 82 to increase the overall weight of the balancing disk 78. The metal ring 84 may be formed from a non-conductive material such as, for example, stainless steel.

Once the metal ring 84 is attached to the balancing disk 78, the balancing disk 78 may be attached to one or both ends of the rotor stack 54. Once the balancing disk 78 is attached to the rotor stack 54, the rotor stack 54 may further be balanced by removing material to create voids 85 at various locations around the metal ring 84. Removing material from the metal ring 84 balances rotation of the rotor stack 54 and accounts for any machine tolerances between the various components of the motor 10 to ensure that rotation of the rotor hub 56 is consistent and constant.

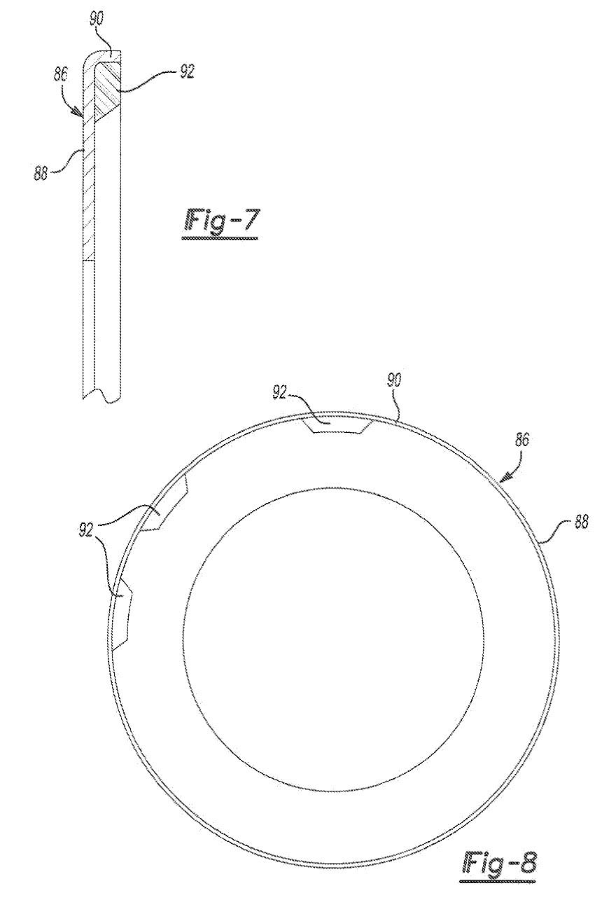

With particular reference to FIGS. 7 and 8, a balancing disk 86 is provided and includes a flat plate 88 and an annular flange 90 disposed at an outer perimeter of the flat plate 88. The balancing disk 86 may be attached to one or both ends of the rotor stack 54 via a similar fashion as the balancing disk 78 and may be balanced by selectively applying a resin 92 at a junction between the flat plate 88 and the annular flange 90. Applying the resin 92 at selective locations around the flat plate 88 locally increases the weight of the balancing disk 86 and therefore improves operation of the motor 10 by ensuring a smooth a consistent rotation of the rotor 16 relative to the stator 14.

With particular reference to FIG. 2, the motor 10 is shown to include a cooling jacket 94. The cooling jacket 94 may fully encompass the first wall 28 of the housing to cool the stator 14. If the stator includes an electromagnet 48 including an outer diameter that is substantially equal to the outer surface 52 of the first wall 28 of the housing 12, the cooling jacket 94 may be in contact with the electromagnet 48 of the stator 14. The cooling jacket 94 may circulate a coolant around the housing 12 and stator 14 to cool the stator 14 and allow the motor 10 to operate at higher speeds and/or torques.

For example, the motor 10 may be able to run at a peek output (i.e, at a voltage higher than a rated voltage) for a longer period of time if the outer diameter of the stator 14 is cooled via the cooking jacket. Therefore, the cooling jacket 94 improves the overall efficiency of the motor and allows the motor to run at a higher voltage, and thus at a higher speed, for a longer period of time.

With particular reference to FIG. 9, the planetary-gear set 26 is shown as being received within the opening 24 defined between surfaces 70, 72 of the rotor hub 56. Packaging the planetary-gear set 26 generally within the housing 12 of the motor 10 decreases the overall length of the assembled unit, as the planetary-gear set 26 is received within the housing 12 of the motor 10. If the planetary-gear set 26 were positioned external from the housing 12 of the motor 10, the overall assembly of the motor 10 and the planetary-gear set 26 would include a greater length, thereby rendering packaging of the motor 10 and planetary-gear set 26 within the transmission 40 more difficult.

With reference to FIG. 10, the motor 10 and planetary-gear set 26 are shown incorporated into the transmission 40. Because the planetary-gear set 26 is essentially packaged within the housing 12 of the motor 10, the overall size of the transmission 40 may be decreased, which allows for a generally smaller transmission. The smaller size of the transmission 40 allows the transmission 40 to be more easily packaged and incorporated into a vehicle (not shown).

Prior to assembling the motor 10 and planetary-gear set 26, the motor 10 may be bench tested ensure that the motor 10 operates within predetermined operating ranges. Testing the motor 10 on a bench (not shown) prior to assembly of the planetary-gear set 26 and assembly of the motor 10 to the transmission 40 allows the motor 10 to be validated without first requiring incorporation of the planetary-gear set 26 and transmission 40.

If the bench includes a pseudo housing (not shown) that mimics a housing of the transmission 40, the cooling jacket 94 may be incorporated into the pseudo housing to allow the motor to run at or above a rated speed to fully test the motor 10 prior to assembling the planetary-gear set 26 into the motor or the motor 10 into the transmission 40.

Testing the motor 10 prior to assembly of the planetary-gear set 26 into the housing 12 of the motor 10 or assembly of the motor 10 into the transmission 40 allows for detection of a defective or faulty motor 10 in advance of assembling the motor 10 to the planetary-gear set 26 or transmission 40 and therefore saves operational costs during manufacturing.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A motor comprising:
a stator;
a rotor supported by a rotor hub for rotation relative to said stator;
a housing fixedly supporting said stator and rotatably supporting said rotor and including a first and enclosing said stator, said rotor, and said rotor hub and a second end exposing said stator, said rotor, and said rotor hub to define an opening within said rotor and said rotor hub.

2. The rotor of claim 1, wherein said housing includes a first wall extending proximate to and supporting said stator and a second wall positioned substantially parallel to said first wall and extending proximate to and supporting said rotor hub.

3. The motor of claim 2, wherein said housing includes an end cap joining said first wall and said second wall.

4. The motor of claim 3, wherein said end cap includes at least a portion thereof formed at a angle relative to said first wall and said second wall.

5. The motor of claim 2, wherein said rotor hub includes a first extension, a second extension, and a cross member joining said first extension and said second extension, said first extension, said second extension, and said cross member cooperating to define a recess.

6. The motor of claim 5 wherein said second wall of said housing is received within said recess of said rotor hub such that said second wall is substantially parallel to said first extension and said second extension.

7. The motor of claim 5, further comprising a bearing assembly disposed between said second wall of said housing and at least one of said first extension to facilitate rotation of said rotor hub to rotate relative to said housing.

8. The motor of claim 7, wherein said second wall of said housing is disposed substantially within said recess.

9. The motor of claim 1, further comprising a bearing assembly disposed between said housing and said rotor hub, said bearing assembly including a first bearing separated from a second bearing by a resolver assembly.

10. The motor of claim 1, further comprising a planetary-gear set received within said opening of said rotor hub to position said planetary-gear set at least partially within said housing and within said rotor and said stator.

11. The motor of claim 1, further comprising at least one balancing disk including a flat plate having a radial flange extending from a surface of said bearing plate at an outer perimeter of said bearing plate.

12. The motor of claim 11, further comprising at least one of a resin and a metal ring disposed at a junction of said surface of said balancing disk and said flange to selectively add weight to said balancing disk.

13. The motor of claim 12, wherein said metal ring is formed from a non-conductive material.

14. The motor of claim 1, further comprising a cooling jacket axially surrounding said housing and said stator to selectively circulate coolant around said housing and said stator.

15. The motor of claim 1, wherein said stator includes an outer diameter substantially equal to an outer diameter of said housing.

16. The motor of claim 1, wherein said stator extends at least partially into a wall of said housing.

17. The motor of claim 1, wherein said stator extends through said housing.

18. A transmission comprising:
a stator;
a transmission motor housing;
a motor disposed at least partially within said transmission motor housing, said motor including:
a rotor supported by a rotor hub for rotation relative to said stator; and
a motor housing fixedly supporting said stator and rotatably supporting said rotor, said motor including a first end enclosing said stator, said rotor, and said rotor hub and a second end exposing said stator, said rotor, and said rotor hub to define an opening within said rotor and said rotor hub.

19. The transmission of claim 18, further comprising a planetary-gear set disposed within said opening of said rotor hub.

20. The transmission of claim 18, wherein said stator extends at least partially into said motor housing.
